(19) United States
(12) Patent Application Publication
(10) Pub. No.: US 2026/0163610 A1
(43) Pub. Date: Jun. 11, 2026

(54) MEASUREMENT SYSTEM FOR SCATTERING CHARACTERISTICS BASED ON RECONFIGURABLE INTELLIGENT SURFACE AND METHOD THEREOF, AND NON-TRANSITORY COMPUTER READABLE STORAGE MEDIUM

(71) Applicant: NATIONAL CHUNG CHENG UNIVERSITY, CHIAYI (TW)

(72) Inventors: Shih-Cheng LIN, Taitung County (TW); Sheng-Fuh CHANG, Chiayi County (TW); Chia-Chan CHANG, Chiayi City (TW); You-Cheng CHEN, Chiayi County (TW); Wei-Lun HSU, Tainan City (TW)

(21) Appl. No.: 19/362,469

(22) Filed: Oct. 19, 2025

(30) Foreign Application Priority Data
Dec. 9, 2024 (TW) 113147683

(51) Int. Cl. H04B 7/04; H04W 24/08

(52) U.S. Cl. CPC H04B 7/04013; H04W 24/08

(57) ABSTRACT

A measurement system for scattering characteristics based on a reconfigurable intelligent surface (RIS) is configured to measure the RIS. A turntable is configured to dispose the RIS. A measurement device is disposed corresponding to the turntable. A processing device includes a memory and a processor. The processor drives the turntable to rotate to an angle, and performs an all-state measurement operation including switching all of a plurality of predetermined states of the RIS within a sampling time, and measuring the RIS by the measurement device to obtain a measurement result of the RIS corresponding to the angle. The processor confirms whether the turntable has completed all measurement angles to generate a confirmation result, and determines whether to change the angle and repeatedly perform the all-state measurement operation according to the confirmation result, and evaluates scattering characteristics of the RIS according to the confirmation result and the measurement result.

### RELATED APPLICATIONS

This application claims priority to Taiwan Application Serial Number 113147683, filed Dec. 9, 2024, which is herein incorporated by reference.

### BACKGROUND

### Field of Invention

The present disclosure relates to a measurement system and a method thereof and a non-transitory computer readable storage medium, and more particularly to a measurement system for scattering characteristics based on a reconfigurable intelligent surface (RIS) and a method thereof and a non-transitory computer readable storage medium.

### Description of Related Art

A reconfigurable intelligent surface (RIS) is an emerging communication technology that controls the propagation of electromagnetic waves by dynamically adjusting electromagnetic characteristics of the surface, and is applied to enhance the performance of fifth-generation (5G) and future sixth-generation (6G) communication systems. It can effectively solve communication blind spots caused by obstacles such as buildings and trees, improve the efficiency of spectrum and space utilization, and reduce path loss in high-frequency band transmission. In addition, the RIS features low power consumption, light weight, and ease of deployment, and can be flexibly applied to various environments. Therefore, accurately understanding the complete electromagnetic characteristics of the RIS to optimize network deployment and improve the overall performance and reliability of communication systems is an important issue. In other words, how to measure and understand the electromagnetic characteristics of the RIS becomes essential in communication. This not only helps operators further plan deployment fields but also diagnose its electromagnetic characteristics.

In conventional antenna measurement systems, an antenna is typically fixed on a turntable to be tested, and its radiation pattern is measured by rotation. When extended to an antenna array, it is still necessary to determine the excitation source of each antenna in advance and then measure the field pattern. If additional factors such as beamforming scan angle and bandwidth are considered, the time and complexity required for measurement will significantly increase. Accordingly, the market currently lacks a measurement system for scattering characteristics based on the RIS and a method thereof and a non-transitory computer readable storage medium that can quickly perform measurements while improving accuracy and efficiency of measurements. Thus, relevant industry players are all seeking solutions to address this issue.

### SUMMARY

An aspect of the present disclosure provides a measurement system for scattering characteristics based on a reconfigurable intelligent surface (RIS), which is configured to measure the RIS. The measurement system for the scattering characteristics based on the RIS includes a turntable, a measurement device and a processing device. The turntable is configured to dispose the RIS. The measurement device is disposed corresponding to the turntable. The processing device is connected to the turntable and the measurement device, and includes a memory and a processor. The memory stores an angle and a sampling time, in which the angle is initially set to 0 degrees. The processor is signally connected to the RIS, the turntable, the measurement device and the memory. The processor drives the turntable to rotate to the angle, and performs an all-state measurement operation. The all-state measurement operation includes switching all of a plurality of predetermined states of the RIS within the sampling time, and measuring the RIS by the measurement device to obtain a measurement result of the RIS corresponding to the angle. The processor confirms whether the turntable has completed all measurement angles to generate a confirmation result, and determines whether to change the angle and repeatedly perform the all-state measurement operation according to the confirmation result, and evaluates scattering characteristics of the RIS according to the confirmation result and the measurement result.

An aspect of the present disclosure provides a method for measuring scattering characteristics based on a reconfigurable intelligent surface (RIS), which is configured to measure the RIS. The method for measuring the scattering characteristics based on the RIS includes following steps: acquiring an angle and a sampling time from a memory by a processor, in which the angle is initially set to 0 degrees; driving a turntable to rotate to the angle by the processor; performing an all-state measurement operation by the processor, and the all-state measurement operation includes switching all a plurality of predetermined states of the RIS within the sampling time, and measuring the RIS by a measurement device to obtain a measurement result of the RIS corresponding to the angle; and confirming whether the turntable has completed all measurement angles to generate a confirmation result, and determining whether to change the angle and repeatedly perform the all-state measurement operation according to the confirmation result, and evaluating the scattering characteristics of the RIS according to the confirmation result and the measurement result by the processor.

Another aspect of the present disclosure provides a non-transitory computer readable storage medium having a plurality of instructions. When the instructions are executed on a processor, the processor is caused to execute a method for measuring scattering characteristics based on a reconfigurable intelligent surface (RIS). The method for measuring the scattering characteristics based on the RIS includes following steps: acquiring an angle and a sampling time from a memory by a processor, in which the angle is initially set to 0 degrees; driving a turntable to rotate to the angle by the processor; performing an all-state measurement operation by the processor, in which the all-state measurement operation includes switching all a plurality of predetermined states of the RIS within the sampling time, and measuring the RIS by a measurement device to obtain a measurement result of the RIS corresponding to the angle; and confirming whether the turntable has completed all measurement angles to generate a confirmation result, and determining whether to change the angle and repeatedly perform the all-state measurement operation according to the confirmation result, and evaluating the scattering characteristics of the RIS according to the confirmation result and the measurement result by the processor.

### BRIEF DESCRIPTION OF THE DRAWINGS

FIG. 1 is a schematic diagram of a measurement system for scattering characteristics based on a reconfigurable intelligent surface according to a first embodiment of the present disclosure;

FIG. 2 is a flow chart of a method for measuring scattering characteristics based on a reconfigurable intelligent surface according to a second embodiment of the present disclosure; and

FIG. 3 is a flow chart of a method for measuring scattering characteristics based on a reconfigurable intelligent surface according to a third embodiment of the present disclosure.

### DETAILED DESCRIPTION

The following will illustrate multiple embodiments of the present disclosure with reference to the drawings. For the purpose of clarity, many practical details will be described together in the following description. However, it should be understood that these practical details should not be used to limit the present disclosure. That is, in some embodiments of the present disclosure, these practical details are not necessary. In addition, in order to simplify the drawings, some conventional structures and components will be illustrated in the drawings in a simple schematic manner; and repeated components may be represented by the same number.

In addition, in this article, when a certain component (or unit or module, etc.) is “connected” to another component, it may mean that the component is directly connected to the other component, or it may mean that a certain component is indirectly connected to the other component, that is, there are other components between the component and the other component. When it is clearly stated that a certain component is “directly connected” to another component, it indicates that there are no other components between the component and the other component. The terms first, second, third, etc. are only used to describe different components, and do not limit the components themselves. Therefore, the first component can also be renamed as the second component. Moreover, the combination of components/units/circuits in this article is not a generally known, conventional or conventional combination in this field, and whether the components/units/circuits themselves are known cannot be used to determine whether their combination relationship can be easily completed by a person having ordinary skill in the art.

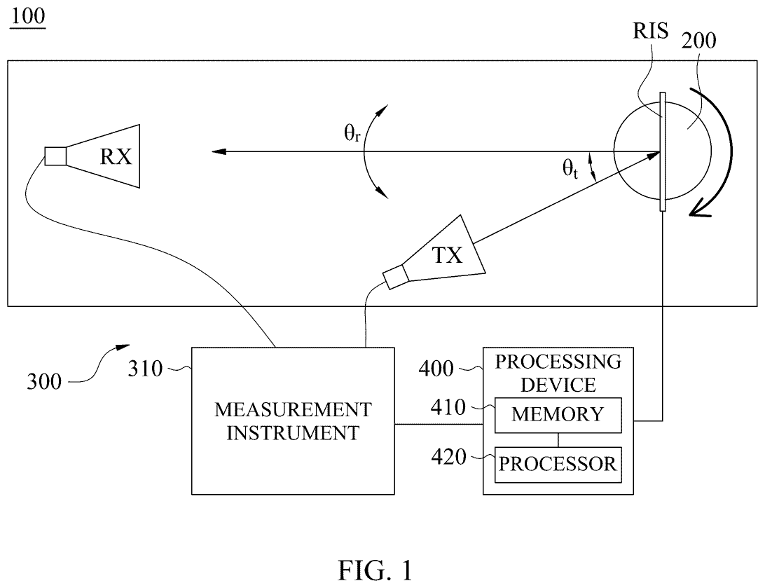

Please refer to FIG. 1, which is a schematic diagram of a measurement system 100 for scattering characteristics based on a reconfigurable intelligent surface (RIS) according to a first embodiment of the present disclosure. The measurement system 100 for the scattering characteristics based on the RIS is configured to measure the RIS, and includes a turntable 200, a measurement device 300 and a processing device 400. The turntable 200 is configured to dispose the RIS. The measurement device 300 is disposed corresponding to the turntable 200. The processing device 400 is connected to the turntable 200 and the measurement device 300, and includes a memory 410 and a processor 420. The memory 410 stores an angle and a sampling time, in which the angle is initially set to 0 degrees (an initial angle of the turntable 200 is 0 degrees), and the sampling time is set to microsecond level, and a preferable range is from 100 microseconds (μs) to 200 microseconds. In one embodiment, the sampling time is set to 130 microseconds, but the present disclosure is not limited to the above. The processor 420 is signally connected to the RIS, the turntable 200, the measurement device 300 and the memory 410. The processor 420 drives the turntable 200 to rotate to the angle (e.g., the angle is 1 degree, and the turntable 200 rotates clockwise by 1 degree), and performs an all-state measurement operation. The all-state measurement operation includes switching all of a plurality of predetermined states of the RIS within the sampling time, and measuring the RIS by the measurement device 300 to obtain a measurement result of the RIS corresponding to the angle. The processor 420 confirms whether the turntable 200 has completed all measurement angles to generate a confirmation result, and determines whether to change the angle and repeatedly perform the all-state measurement operation according to the confirmation result, and evaluates the scattering characteristics of the RIS according to the confirmation result and the measurement result.

In this way, the measurement system 100 for the scattering characteristics based on the RIS of the present disclosure utilizes the adjustability of the RIS in combination with the measurement turntable 200. Whenever the turntable 200 rotates a sampling angle and simultaneously switches the state distribution of all electromagnetic units of the RIS, the frequency response corresponding to the angle can be obtained. Once the turntable 200 completes a full 360-degree rotation, the complete scattering characteristics of the RIS can be measured.

Specifically, the measurement device 300 includes a transmitter TX, a receiver RX and a measurement instrument 310. The transmitter TX is configured to transmit a first signal to the RIS. The RIS generates a second signal after receiving the first signal. The receiver RX is configured to receive the second signal from the RIS. The measurement instrument 310 is signally connected to the transmitter TX, the receiver RX and the processing device 400. The measurement instrument 310 is configured to control the transmitter TX and the receiver RX. The second signal corresponds to the scattering characteristics of the RIS. Furthermore, the first signal is transmitted to the RIS along a first direction, and the second signal is transmitted to the receiver RX along a second direction. The first signal and the second signal are both electromagnetic wave signals. The first signal has an incident angle θₜ (incident angle range), and the second signal has a reflection angle θᵣ (reflection angle range). The incident angle θₜ and the reflection angle θᵣ are determined according to the first direction and the second direction.

In one embodiment, the RIS may include a plurality of electromagnetic units distributed in two dimensions. The measurement instrument 310 may be a radiation field measurement device, which is configured to measure the radiation field of the RIS. The memory 410 may include a random access memory (RAM) or another type of dynamic storage device that can store information and instructions for execution by the processor 420. The processor 420 may include any type of processor, microprocessor, or field programmable gate array (FPGA) that can compile and execute instructions. The processor 420 may be a central processing unit (CPU), a computer, a mobile device processor, a cloud processor or other high-performance computing processor, which may include a single device (e.g., a single core) or a group of devices (e.g., multiple cores). In addition, the aforementioned predetermined states are different from each other and include an open state (ON) and a closed state (OFF). The scattering characteristics include an electromagnetic characteristic, and the electromagnetic characteristic includes at least one of a phase, a gain, and a bandwidth. The incident angle θₜ may be between −80 degrees and 80 degrees, and the reflection angle θᵣ may be between −80 degrees and 80 degrees; the incident angle θt is preferably 30 degrees, and the reflection angle θᵣ is preferably 0 degrees. However, the present disclosure is not limited to the above.

The processor 420 confirms whether the turntable 200 has completed all measurement angles to generate a confirmation result (i.e., the turntable 200 completes the rotation through all the angles). When the confirmation result is no, the processor 420 changes the angle and repeatedly performs the all-state measurement operation. On the contrary, when the confirmation result is yes, the processor 420 ends the all-state measurement operation, and evaluates and displays the scattering characteristics of the RIS according to the measurement result. The angle is greater than or equal to 0 degrees and less than or equal to 360 degrees. In addition, the processor 420 may change the angle according to an increment operation, and the increment operation includes incrementing the angle according to an increment value. The increment value may be 0.5 degrees, 1 degree, or 2 degrees, and is a fixed value, but the present disclosure is not limited to the above. For example, if the incremental value is 1 degree, the angles may sequentially be 0 degrees, 1 degree, 2 degrees, . . . , 358 degrees, 359 degrees, and 360 degrees. When the angle is incremented to 360 degrees, the turntable 200 is deemed to have completed all the measured angles.

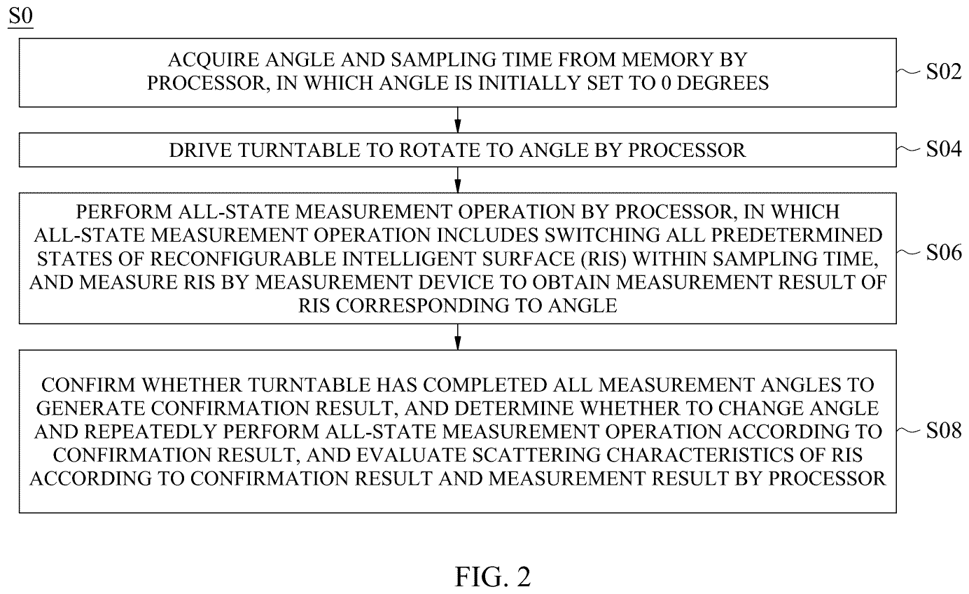

Please refer to FIG. 1 and FIG. 2 together, in which FIG. 2 is a flow chart of a method S0 for measuring scattering characteristics based on a reconfigurable intelligent surface (RIS) according to a second embodiment of the present disclosure. The method S0 for measuring the scattering characteristics based on the RIS is configured to measure the RIS, and includes steps S02, S04, S06, and S08. Step S02 includes acquiring an angle and a sampling time from a memory 410 by a processor 420, in which the angle is initially set to 0 degrees. Step S04 includes driving a turntable 200 to rotate to the angle by the processor 420. Step S06 includes performing an all-state measurement operation by the processor 420, in which the all-state measurement operation includes switching all a plurality of predetermined states of the RIS within the sampling time, and measuring the RIS by a measurement device 300 to obtain a measurement result of the RIS corresponding to the angle. Step S08 includes confirming whether the turntable 200 has completed all measurement angles to generate a confirmation result, and determining whether to change the angle and repeatedly perform the all-state measurement operation according to the confirmation result, and evaluating the scattering characteristics of the RIS according to the confirmation result and the measurement result by the processor 420.

The all-state measurement operation mentioned above further includes controlling a transmitter TX and a receiver RX by a measurement instrument 310 of the measurement device 300; transmitting a first signal to the RIS by the transmitter TX of the measurement device 300, in which the RIS generates a second signal after receiving the first signal; and receiving a second signal from the RIS by the receiver RX of the measurement device 300, in which the second signal corresponds to the scattering characteristics of the RIS.

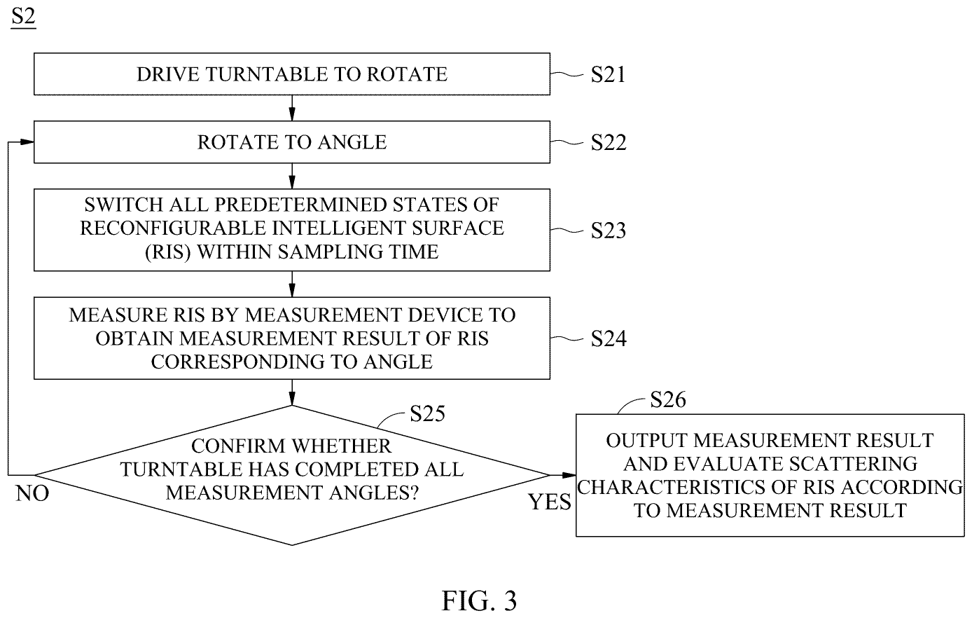

Please refer to FIG. 1, FIG. 2 and FIG. 3 together, in which FIG. 3 is a flow chart of a method S2 for measuring scattering characteristics based on a reconfigurable intelligent surface (RIS) according to a third embodiment of the present disclosure. The method S2 for measuring the scattering characteristics based on the RIS is configured to measure the RIS, and includes steps S21, S22, S23, S24, S25, and S26. Step S21 includes driving a turntable 200 to rotate by a processor 420. Step S22 includes rotating the turntable 200 to a specific angle. Step S23 includes switching all a plurality of predetermined states of the RIS by the processor 420 within a sampling time. Step S24 includes measuring the RIS by a measurement device 300 to obtain a measurement result of the RIS corresponding to the angle. Step S25 includes confirming whether the turntable 200 has completed all measurement angles to generate a confirmation result by the processor 420. When the confirmation result is no, the processor 420 changes the angle and repeatedly performs steps S22, S23, S24, and S25. On the contrary, when the confirmation result is yes, the processor 420 executes step S26. Step S26 includes outputting the measurement result by the processor 420, and evaluating the scattering characteristics of the RIS according to the measurement result.

The above step S22 may further include changing the angle according to an incremental operation by the processor 420, in which the incremental operation includes incrementing the angle according to an incremental value, and the incremental value is 0.5 degrees, 1 degree or 2 degrees, and is a fixed value. The above steps S23 and S24 may be equivalent to the all-state measurement operation mentioned in step S06 of FIG. 2.

Thus, the methods S0 and S2 for measuring the scattering characteristics based on the RIS of the present disclosure integrates the RIS with the high-precision measurement turntable 200 to be capable of comprehensively measuring the electromagnetic characteristics of the RIS in an efficient and accurate manner.

The measurement methods S0 and S2 for measuring the scattering characteristics based on the RIS of the present disclosure can be implemented through computer program products. The order of the implementation steps described in the above embodiments can be adjusted, combined or omitted according to actual needs. The above embodiments can be implemented using a computer program product, which can include a machine-readable medium (non-transitory computer readable storage medium) storing multiple instructions, and these instructions can program a computer to perform the steps in the above embodiments. The machine-readable medium can be, but is not limited to, a floppy disk, an optical disk, a read-only disk, a magneto-optical disk, a read-only memory, a random access memory, an erasable programmable read-only memory (EPROM), an electronically erasable programmable read-only memory (EEPROM), an optical card or a magnetic card, a flash memory, or any machine-readable medium suitable for storing electronic instructions. Furthermore, the embodiments of the present disclosure can also be downloaded as a computer program product, which can be transferred from a remote computer to a requesting computer by using a data signal of a communication connection (e.g., a connection such as a network connection).

It can be seen from the above embodiments that the present disclosure has following advantages. First, when the measurement turntable rotates a measuring angle each time, the RIS cooperates with the measurement instrument to switch all predetermined state distributions within the sampling time, which can ensure that the electromagnetic characteristics at each angle can be recorded and analyzed in detail. When the measurement turntable completes the rotation of all angles, the complete electromagnetic characteristic data of the RIS in various states can be obtained, which provides an important basis for subsequent research and application. Second, by measuring sampling points of the signal and combining dynamic adjustment ability of the RIS, the electromagnetic response of the RIS in three-dimensional space can be effectively understood, so as to be further applied to the deployment planning of the actual field, and solve the issue of a long electromagnetic response time of a conventional measurement of the RIS. Third, a more efficient measurement technology is proposed for the beam scanning and frequency response of the RIS, which can not only quickly switch and measure different states of the RIS, but also accurately measure its electromagnetic characteristics at different scanning angles and frequencies. This technology can greatly shorten the measurement time through the fast switching and control mechanism, while improving the accuracy and efficiency of the measurement.

Although the present disclosure has been disclosed in the above embodiments, it is not intended to limit the present disclosure. Anyone skilled in the art can make various changes and modifications without departing from the spirit and scope of the present disclosure. Therefore, the scope of protection of the invention shall be determined by the scope of the attached claims.

What is claimed is:

1. A measurement system for scattering characteristics based on a reconfigurable intelligent surface (RIS), configured to measure the RIS, the measurement system for the scattering characteristics based on the RIS comprising:
a turntable, configured to dispose the RIS;
a measurement device, disposed corresponding to the turntable; and
a processing device, connected to the turntable and the measurement device, and comprising:
a memory, storing an angle and a sampling time, wherein the angle is initially set to 0 degrees; and
a processor, signally connected to the RIS, the turntable, the measurement device and the memory, and the processor driving the turntable to rotate to the angle and performing an all-state measurement operation, and the all-state measurement operation comprising switching all of a plurality of predetermined states of the RIS within the sampling time, and measuring the RIS by the measurement device to obtain a measurement result of the RIS corresponding to the angle, and the processor confirming whether the turntable has completed all measurement angles to generate a confirmation result, and determining whether to change the angle and repeatedly perform the all-state measurement operation according to the confirmation result, and evaluating the scattering characteristics of the RIS according to the confirmation result and the measurement result.

2. The measurement system for the scattering characteristics based on the RIS of claim 1, wherein the measurement device comprises:
a transmitter, configured to transmit a first signal to the RIS, and the RIS generating a second signal after receiving the first signal;
a receiver, configured to receive the second signal from the RIS; and
a measurement instrument, signally connected to the transmitter, the receiver and the processing device, the measurement instrument being configured to control the transmitter and the receiver, and the second signal corresponding to the scattering characteristics of the RIS.

3. The measurement system for the scattering characteristics based on the RIS of claim 1, wherein,
when the confirmation result is no, the processor changes the angle and repeatedly performs the all-state measurement operation; and
when the confirmation result is yes, the processor ends the all-state measurement operation, and evaluates and displays the scattering characteristics of the RIS according to the measurement result;
wherein the angle is greater than or equal to 0 degrees and less than or equal to 360 degrees.

4. The measurement system for the scattering characteristics based on the RIS of claim 3, wherein,
the processor changes the angle according to an incremental operation, and the incremental operation comprises incrementing the angle according to an incremental value, and the incremental value is 0.5 degrees, 1 degree or 2 degrees, and is a fixed value; and
when the angle is incremented to 360 degrees, it indicates that the turntable has completed all the measurement angles.

5. The measurement system for the scattering characteristics based on the RIS of claim 1, wherein,
the predetermined states are different from each other and comprise an open state and a closed state; and
the scattering characteristics comprise an electromagnetic characteristic, and the electromagnetic characteristic comprises at least one of a phase, a gain and a bandwidth.

6. A method for measuring scattering characteristics based on a reconfigurable intelligent surface (RIS), configured to measure the RIS, the method for measuring the scattering characteristics based on the RIS comprising following steps:
acquiring an angle and a sampling time from a memory by a processor, wherein the angle is initially set to 0 degrees;
driving a turntable to rotate to the angle by the processor;
performing an all-state measurement operation by the processor, wherein the all-state measurement operation comprises switching all a plurality of predetermined states of the RIS within the sampling time, and measuring the RIS by a measurement device to obtain a measurement result of the RIS corresponding to the angle; and
confirming whether the turntable has completed all measurement angles to generate a confirmation result, and determining whether to change the angle and repeatedly perform the all-state measurement operation according to the confirmation result, and evaluating the scattering characteristics of the RIS according to the confirmation result and the measurement result by the processor.

7. The method for measuring the scattering characteristics based on the RIS of claim 6, wherein the all-state measurement operation further comprises:
controlling a transmitter and a receiver by a measurement instrument of the measurement device;
transmitting a first signal to the RIS by the transmitter of the measurement device, wherein the RIS generates a second signal after receiving the first signal; and
receiving the second signal from the RIS by the receiver of the measurement device, wherein the second signal corresponds to the scattering characteristics of the RIS.

8. The method for measuring the scattering characteristics based on the RIS of claim 6, further comprising:
when the confirmation result is no, changing the angle and repeating the all-state measurement operation by the processor; and
when the confirmation result is yes, ending the all-state measurement operation and evaluating and displaying the scattering characteristics of the RIS according to the measurement result by the processor;
wherein the angle is greater than or equal to 0 degrees and less than or equal to 360 degrees.

9. The method for measuring the scattering characteristics based on the RIS of claim 8, further comprising:
changing the angle according to an incremental operation by the processor, wherein the incremental operation comprises incrementing the angle according to an incremental value, and the incremental value is 0.5 degrees, 1 degree or 2 degrees, and is a fixed value;
when the angle is incremented to 360 degrees, it indicates that the turntable has completed all the measurement angles.

10. The method for measuring the scattering characteristics based on the RIS of claim 6, wherein,
the predetermined states are different from each other and comprise an open state and a closed state; and
the scattering characteristics comprise an electromagnetic characteristic, and the electromagnetic characteristic comprises at least one of a phase, a gain and a bandwidth.

11. A non-transitory computer readable storage medium having a plurality of instructions, when the instructions are executed on a processor, the processor is caused to execute a method for measuring scattering characteristics based on a reconfigurable intelligent surface (RIS), the method for measuring the scattering characteristics based on the RIS comprising following steps:
acquiring an angle and a sampling time from a memory by a processor, wherein the angle is initially set to 0 degrees;
driving a turntable to rotate to the angle by the processor;
performing an all-state measurement operation by the processor, wherein the all-state measurement operation comprises switching all a plurality of predetermined states of the RIS within the sampling time, and measuring the RIS by a measurement device to obtain a measurement result of the RIS corresponding to the angle; and
confirming whether the turntable has completed all measurement angles to generate a confirmation result, and determining whether to change the angle and repeatedly perform the all-state measurement operation according to the confirmation result, and evaluating the scattering characteristics of the RIS according to the confirmation result and the measurement result by the processor.

12. The non-transitory computer readable storage medium of claim 11, wherein the all-state measurement operation further comprises:
controlling a transmitter and a receiver by a measurement instrument of the measurement device;
transmitting a first signal to the RIS by the transmitter of the measurement device, wherein the RIS generates a second signal after receiving the first signal; and
receiving the second signal from the RIS by the receiver of the measurement device, wherein the second signal corresponds to the scattering characteristics of the RIS.

13. The non-transitory computer readable storage medium of claim 11, wherein the method for measuring the scattering characteristics based on the RIS further comprises:
when the confirmation result is no, the processor changes the angle and repeatedly performs the all-state measurement operation; and
when the confirmation result is yes, the processor ends the all-state measurement operation, and evaluates and displays the scattering characteristics of the RIS according to the measurement result;
wherein the angle is greater than or equal to 0 degrees and less than or equal to 360 degrees.

14. The non-transitory computer readable storage medium of claim 13, wherein the method for measuring the scattering characteristics based on the RIS further comprises:
changing the angle according to an incremental operation by the processor, wherein the incremental operation comprises incrementing the angle according to an incremental value, and the incremental value is 0.5 degrees, 1 degree or 2 degrees, and is a fixed value;
when the angle is incremented to 360 degrees, it indicates that the turntable has completed all the measurement angles.

15. The non-transitory computer readable storage medium of claim 11, wherein
the predetermined states are different from each other and comprise an open state and a closed state; and
the scattering characteristics comprise an electromagnetic characteristic, and the electromagnetic characteristic comprises at least one of a phase, a gain and a bandwidth.
